(19) United States
(12) Patent Application Publication
(10) Pub. No.: US 2006/0194469 A1
(43) Pub. Date: Aug. 31, 2006

(54) Lock Connector

(75) Inventors: Tomoyuki Miyakawa, Shizuoka (JP); Kazuto Ohtaka, Shizuoka (JP); Shigeru Tanaka, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Yazaki Corporation, Tokyo (JP)

(21) Appl. No.: 11/164,340

(22) Filed: Nov. 18, 2005

(30) Foreign Application Priority Data
Feb. 4, 2005 (JP) 2005-028937

(51) Int. Cl. H01R 13/627

(52) U.S. Cl. 439/357

(57) ABSTRACT

A compact lock connector, by which a connector housing is prevented from becoming large due to a lock-releasing mechanism, is provided. The lock connector includes: one connector housing having a flexible locking arm; and an opposite connector housing having a locking part that engages with the locking arm, wherein a slider for releasing a lock is mounted to the one connector housing and the slider has a lock-releasing part that bends the locking arm in a lock-releasing direction when the slider moves in a connector-separating direction.

### BACKGROUND OF THE INVENTION

(1) Field of the Invention

The present invention relates to a lock connector having a slider for releasing a lock of fitting (i.e. coupling) of male and female connectors.

(2) Description of the Related Art

FIG. 16 shows an example of a conventional lock connector illustrating a fitting state of male and female connectors (for example, see Japanese Patent Application Laid-Open No. H10-255897).

Each connector includes at least a connector housing 61 or 62 made of synthetic resin and terminals with electric wire (not shown in the figure) mounted in the connector housing.

The one connector housing 61 includes an outside hood part 70 and an inside inner housing 63. The inner housing 63 acts as a terminal-receiving part and has tube parts 64 for the respective terminals at the rear half thereof, wherein a ring-shaped waterproof rubber stopper (not shown in the figure), which adheres to an outer peripheral surface of an electric wire of a female terminal, is inserted into each tube part 64.

The hood part 70 is provided with a flexible locking arm 65. The opposite connector housing 62 is provided with a locking projection 66 which engages in a front end part 67 of the locking arm 65. A middle part in the length direction of the locking arm 65 is supported by the connector housing 61 with a support wall 71 like a seesaw. When both connectors are coupled with each other as shown in FIG. 16, the locking projection 66 engages with a recess at a front end side of the locking arm 65. An operation part 68 at a rear end side of the locking arm 65 is pushed down, so that the lock of fitting (i.e. coupling) of both connectors is released.

Male terminals with electric wire (not shown in the figure) are received in the opposite connector housing 62. A tab-shaped contacting part at a front half of the male terminal protrudes in a hood part 69. The male and female terminals are connected to each other at the same time when both connectors 61 and 62 are coupled with each other.

However, as for the above conventional lock connector, since a large space for allowing the locking arm 65 to bend is necessary upon releasing the lock of both connectors 61 and 62, there is a problem that the connector housing 61 becomes large in its height direction. Further, since the operation part 68 for bending of the locking arm 65 protrudes long backward, there is a problem that the locking structure, that is, the connector housing 61 becomes large in its depth direction.

### SUMMARY OF THE INVENTION

It is therefore an objective of the present invention to solve the above problem and to provide a compact lock connector, by which the connector housing is prevented from becoming large due to the lock-releasing mechanism.

In order to attain the above objective, the present invention is to provide a lock connector including:

one connector housing having a flexible locking arm; and

an opposite connector housing having a locking part that engages with the locking arm,

wherein a slider for releasing a lock between the one connector housing and the opposite connector housing is mounted to the one connector housing and the slider has a lock-releasing part that bends the locking arm in a lock-releasing direction when the slider is moved in a connector-separating direction.

With the construction described above, the slider for lock-releasing is mounted on the one connector housing, the one connector housing is coupled with the opposite connector housing, simultaneously the terminals in both connector housings are connected to one another, the locking part engages with the locking arm so as to lock both connector housings, the slider is moved backward along the connector housing so that the lock-releasing part of the slider bends the locking arm in a lock-releasing direction (i.e. outward direction) so as to release the engagement between the locking part and the locking arm, thereby the lock of both connector housings is released. In comparison with a conventional lock connector, since the slider bends the locking arm in a lock-releasing direction in the present invention, a conventional operation part for bending of a locking arm becomes unnecessary in the present invention.

That is, in the present invention, the connector housing is prevented from becoming large in its height direction due to a large stroke of the operation part for bending of the locking arm. Further, the connector housing is also prevented from becoming large in its depth direction due to a length of the operation part for bending of the locking arm. Therefore, a compact lock connector can be provided.

Preferably, the lock-releasing part has an inclined surface that comes in contact with and pushes the locking arm so as to bend the locking arm.

With the construction described above, the inclined surface of the lock-releasing part of the slider holds, for example, a front end of the locking arm, the inclined surface slidably comes in contact with the front end of the locking arm due to the backward movement of the slider, and the locking arm is smoothly bent in the lock-releasing direction, thereby the lock-release of the connector can be smoothly securely carried out.

Preferably, the lock-releasing part is provided on a flexible lock-releasing arm and the lock-releasing part climbs over the locking arm so as to located in front of the locking arm.

With the construction described above, when the slider is mounted on the connector housing, the lock-releasing arm bends while the slider moves forward, so that the lock-releasing part climbs over the locking arm of the connector housing. Therefore, the lock-releasing part can be smoothly easily arranged in front of the locking arm due to the bending motion of the lock-releasing arm, thereby improving the mounting workability of the slider to the connector housing.

Preferably, the lock-releasing part is located on a side of the locking arm so that the lock-releasing part is capable of bending the locking arm laterally.

With the construction described above, the lock-releasing part bends the locking arm in the lateral direction (horizontal direction) due to the backward movement of the slider so as to release the engagement of the locking arm with the locking part of the opposite connector housing. The locking arm is bent and displaced in parallel along a wall of the connector housing. Therefore, a space for bending of the locking arm in the height direction of the connector is reduced, thereby making the connector housing compact.

Preferably, the lock-releasing part is provided on a flexible lock-releasing arm and the lock-releasing arm enters a side opposite to a lock-releasing bending of the locking arm so that the lock-releasing part is located in front of the locking arm.

With the construction described above, when the slider is mounted to the connector housing, simultaneously the lock-releasing arm bends the locking arm in the lock-releasing direction and the lock-releasing arm enters into the side reverse to the bending of the lock-release, that is, between the connector housing and the locking arm. The lock-releasing arm prevents the locking arm from bending in a direction reverse to the lock-releasing direction. The action (i.e. the lock-releasing action) after the slider is mounted is the same as described above. That is, the lock-releasing part situated in front of the locking arm lifts the locking arm in the lock-releasing direction as the slider moves backward, thereby releasing the engagement of the locking arm with the locking part of the opposite connector housing. Preferably, the opposite connector housing is provided with a receiving part such as a slit part or groove part for allowing the lock-releasing arm to enter therein.

With the construction described above, no excessive bending affects on the locking arm and the resilient characteristic of the locking arm is secured for a long period of time, thereby improving the reliability of the locking of the connector.

Preferably, the slider has a resilient member for returning and the resilient member comes in contact with and pushes a projection of the one connector housing when the slider is moved backward.

With the construction described above, when the slider is moved backward upon the lock-releasing, the resilient member is caught by the projection of the connector housing, so that the resilient member displays its resilient force to return the slider forward relatively to the connector housing, thereby automatically returning the slider to the initial position. Preferably, the resilient member is a resilient arm or resilient band having a ring-shape or half ring-shape.

With the construction described above, an operator does not need to put the slider back, so that the work for lock-releasing becomes easy.

Preferably, the resilient member is a resilient arm and the resilient arm comes in contact with and pushes an inclined surface situated in front of the projection when the slider is moved backward.

With the construction described above, the resilient arm resiliently comes in contact with the inclined surface situated in front of the projection when the slider is moved backward, so that force for moving the slider forward relatively to the connector housing is given, thereby the slider returns to its initial position by the force.

With the construction described above, the slider can be returned to its initial position by the resilient arm having a simple structure, so that the formation of the returning structure of the slider becomes easy with low cost.

Preferably, the slider is a member that covers an outer periphery of the one connector housing.

With the construction described above, an operator can release the lock of both connectors so as to separate both connectors from each other only by a simple pull motion in the connector-separating direction on a condition that the operator holds the connector, that is, the operator holds the slider from both sides. Here, the connector means a connector in which terminals are received in a connector housing of the connector.

With the construction described above, the workability of connector separation can be improved.

### BRIEF DESCRIPTION OF THE DRAWINGS

FIG. 1 is a longitudinal cross sectional view illustrating the first preferred embodiment of a lock connector according to the present invention;

FIG. 2 is a longitudinal cross sectional view illustrating a lock-releasing state of a lock connector according to the present invention;

FIG. 3 is a perspective view illustrating a lock connector according to the present invention before coupling of a connector;

FIG. 4 is an exploded perspective view illustrating the second preferred embodiment of a lock connector according to the present invention;

FIG. 5 is an exploded perspective view illustrating an assembling state of a lock connector according to the present invention before coupling of a connector;

FIG. 6 is a perspective view illustrating a connector-coupling state of a lock connector according to the present invention;

FIG. 7 is a lateral cross sectional view illustrating the third preferred embodiment of a lock connector according to the present invention;

FIG. 8 is an exploded perspective view illustrating the fourth preferred embodiment of a lock connector according to the present invention;

FIG. 9 is an exploded perspective view illustrating an assembling state of a lock connector according to the present invention before coupling of a connector;

FIG. 10 is a perspective view illustrating a connector-coupling state of a lock connector according to the present invention;

FIG. 11 is a perspective view illustrating a lock-releasing state of a lock connector according to the present invention;

FIG. 12 is a lateral cross sectional view illustrating a slider-return mechanism of a lock connector according to the present invention;

FIG. 13 is a primary lateral cross sectional view illustrating an initial state of a slider-return mechanism of a lock connector according to the present invention;

FIG. 14 is a perspective view viewed from the bottom of a lock connector having a mechanism for preventing the slider from coming off according to the present invention;

FIG. 15 is a plan view illustrating another preferred embodiment of a slider-return mechanism of a lock connector according to the present invention; and

FIG. 16 is a perspective view of an example of a conventional lock connector illustrated by notching the inside thereof.

### DESCRIPTION OF THE PREFERRED EMBODIMENTS

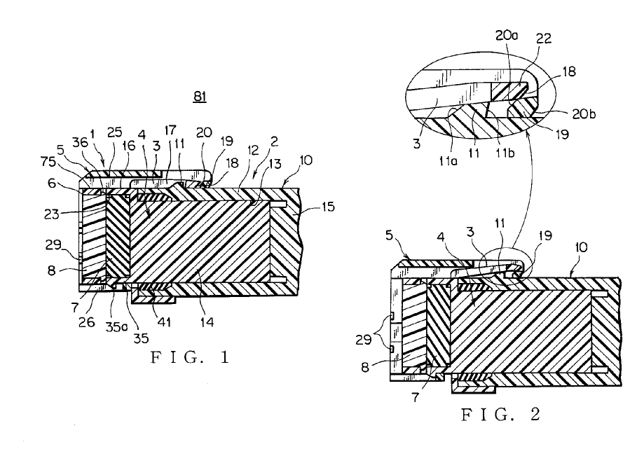

In the following, the preferred embodiments of the present invention will be explained with reference to the attached drawings. FIGS. 1-3 show the first preferred embodiment of a lock connector according to the present invention.

A lock connector 81 according to the present invention is composed of one connector 1 or of one connector 1 and an opposite connector (i.e. mating connector) 2. (This invention mainly relates to the one connector 1.) FIGS. 1 and 2 show coupling states of both connectors 1 and 2.

The one connector 1 includes: a connector housing 4 made of synthetic resin having a flexible cantilever locking arm 3; a slider 5 that is a lock-releasing member made of synthetic resin slidably mounted to the outside of the connector housing 4; a mat seal 7 mounted in the connector housing 4 from a rear opening 6 of the connector housing 4; and a sealing holder 8 made of synthetic resin that presses the mat seal 7 in the connector housing 4 from the rear.

The mounting of the slider 5, mat seal 7 and sealing holder 8 to the one connector housing 4 is carried out before the fitting (coupling) of both connectors 1 and 2. Here, the connector 1 or connector 2 means a connector, in which terminals with electric wire (not shown in the figure) are received in the corresponding connector housing 4 or 10.

The opposite connector 2 includes a locking projection (locking part) 11 that engages with the locking arm 3 on an outer surface of a peripheral wall 12 of the connector housing 10. The locking projection 11 includes an inclined surface 11a (FIG. 2) situated in the front side of the connector-fitting direction and a locking surface 11b situated in the rear side of the connector-fitting direction. A terminal-receiving part 14 (FIG. 1) on the side of the front half of the one connector 1 is fit into a connector-fitting chamber 13 in the peripheral wall 12. The terminal-receiving part 14 includes a plurality of terminal-receiving chambers (not shown in the figure), into which female terminals with electric wire (not shown in the figure) are mounted. A tab-shaped contacting part of a male terminal (not shown in the figure) received in a terminal-receiving part 15 (FIG. 1) of the opposite connector housing 10 of the opposite connector 2 is situated projectingly in the connector-fitting chamber 13.

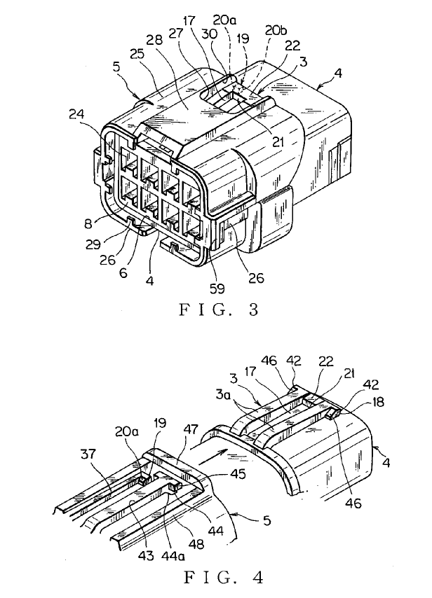

The locking arm 3 is formed on a horizontal wall (upper wall) 16 of a peripheral wall of the connector housing 4, wherein the locking projection 11 engages with a hole part 17 situated at the center in the width direction of the locking arm 3, and a lock-releasing projection (lock-releasing part) 19 of the slider 5 is situated in the proximity of an front side of an inward inclined surface 18 at a front end (end) of the locking arm 3. The lock-releasing projection 19 includes an outward inclined surface 20a (see FIG. 3) situated at a rear end along the inclined surface 18 and an inward inclined surface 20b situated at a front end approximately parallel to the outward inclined surface 20a. The lock-releasing projection 19 is arranged on an inner side of a front end of the slider 5.

The locking arm 3 is formed in a shape shown in FIG. 3 having the rectangular hole part 17 inside, wherein a front end of the hole part 17 is an abutting surface 21 to abut against a perpendicular engaging surface of the locking projection 11, a connection wall 22 continues to an front side of the abutting surface 21, and the inclined surface 18 (see FIG. 1) is formed at a front end of the connection wall 22. As shown in FIG. 1, a base part (rear end) of the locking arm 3 is bent inwardly approximately perpendicularly and integrally continues crossing at right angles with the upper wall 16 at a middle of the connector housing 4 in the length direction thereof (i.e. between the terminal-receiving part 14 at the front half and a sealing holder-receiving part (also as a seal part) 23 at the rear half).

The receiving part 23 situated at the rear half receives the mat seal 7 having a rectangular shape in front view and the sealing holder 8 adhering in front and behind. The mat seal 7 includes hole parts (not shown in the figure) each having a round shape in cross section for guiding terminals with electric wire therethrough. As shown in FIG. 3, the sealing holder 8 includes hole parts 24 having a rectangular shape in cross section for guiding terminals with electric wire therethrough, wherein each hole part 24 is coaxial with the corresponding hole part of the mat seal 7. The hole parts 24 are partitioned by longitudinal and lateral partition walls and formed in parallel in a plurality of steps. As shown in FIG. 1, a thickness of the mat seal 7 is about the same with that of the sealing holder 8. The mat seal 7 includes a lip part on an outer periphery thereof.

The slider 5 is formed in a rectangular pipe-shape in cross section so as to surround (cover) the outside of a rear half of the connector housing 4 and engages with the rear half of the connector housing 4 slidably in the connector-fitting direction. An upper wall 25 of the slider 5 extends forward longer than a lower wall 26 thereof.

The lock-releasing projection 19 for releasing the locking arm 3 of the connector housing 4 is formed on an inner side of a front end of the upper wall 25 of the slider 5. A protection wall 28 (FIG. 3) having an inverse recess-shape in cross section is integrally formed at a middle of the upper wall 25 in the width direction thereof. An opening (or recess) 27 (FIG. 3) for exposing a front half of the locking arm 3 is formed on the protection wall 28 at the front half of the upper wall 25. The locking arm 3 can bend in a lock-releasing direction (upward direction) in the opening 27. The rear half of the locking arm 3 is protected from the outside without any interference in the protection wall 28. The lock-releasing projection 19 is formed, for example, integrally with an inner surface of a perpendicular side wall 30 (FIG. 3) of the protection wall 28 and protrudes inwardly from the inner surface of the side wall 30 in the protection wall 28.

The lock-releasing projection 19 may be formed on a different position (for example, an inner side of a front end of the flexible arm) instead of the side wall 30.

A plurality of inward projections 29 (see FIG. 3) as stoppers are formed at the rear end of the slider 5. Each projection 29 abuts against the rear end of the connector housing 4 so as to prevent the slider 5 from further moving forward. The projection 29 restricts the end position of the forward movement of the slider 5. Here, the forward direction means the connector-fitting direction, while the backward means the connector-parting direction.

FIG. 1 shows an initial state of the slider 5. FIGS. 2 and 3 show a state in which the slider 5 is operated to be moved backward. FIG. 3 shows only the one connector 1 (in its non-fitting state). In these figures, the sealing holder 8 is pressed into a receiving chamber 23 from a rear opening 6 of the connector housing 4 and a locking projection 36 (FIG. 1) is locked by an engaging hole 75.

In FIG. 1, a rear end of a peripheral wall of the receiving part 23 of the connector housing 4 abuts against a front end surface of the projection 29 between the slider 5 and the sealing holder 8. A projection 35a of a flexible arm 35 of a lower wall of the connector housing 4 prevents the slider 5 from coming out backward. A structure of prevention of this backward-coming-out of the slider 5 will be explained with reference to FIG. 14 later on.

The sealing holder 8 compresses the mat seal 7 to allow it to adhere resiliently to an inner wall surface of the receiving part 23 of the connector housing 4 while the sealing holder 8 adheres to an outer peripheral surface of an electric wire in an electric wire-guiding-through hole, thereby preventing water from entering into the connector 1. After or before the complete mounting of the mat seal 7, terminals having electric wire are received in the connector housing 4, thereby constructing the connector 1.

When the slider 5 is slid backward from the state shown in FIG. 1, as shown in FIGS. 2 and 3, the lock-releasing projection 19 at a front end of the slider 5 abuts against an inclined surface 18 at a front end of the locking arm 3 of the connector housing 4 and bends the locking arm 3 outward (upward) so as to allow the locking arm 3 to separate from the locking projection 11 of the opposite connector housing 10 of the opposite connector 2. Thereby, the lock between the connectors 1 and 2 is released. When the connectors 1 and 2 are pulled in the connector-parting direction, the fitting (coupling) of both connectors 1 and 2 is released.

An operator holds and pulls the both sides of the slider 5 with his hands so that the sliding operation of the slider 5 is easily carried out. That is, both connectors 1 and 2 can be easily separated from each other without holding the connector housing 4.

In FIG. 1, the reference numeral 41 denotes a ring-shaped waterproof packing which adheres to between the connector housing 4 and the opposite connector housing 10. The opposite connector housing 10 may be arranged at an end of a wiring harness or directly attached on an instrument or the like.

FIGS. 4-6 show the second preferred embodiment of a lock connector according to the present invention.

A lock connector 82 is a connector, in which the lock connector according to the first preferred embodiment is further provided with means for provisionally locking the slider 5 to the one connector housing 4 and an arm 37 having a lock-releasing projection 19.

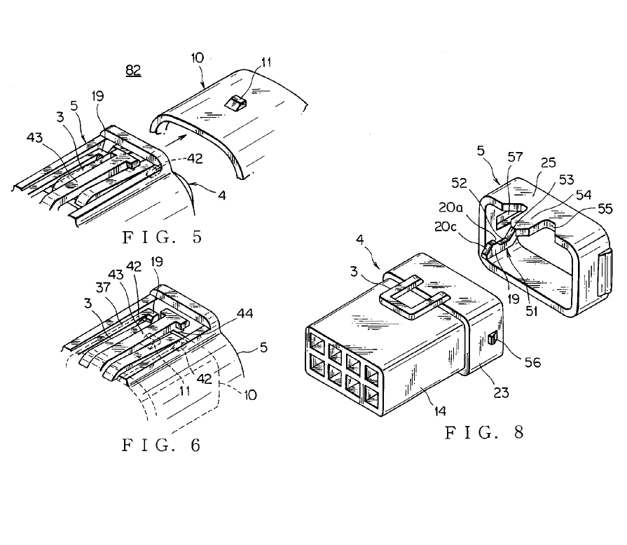

FIG. 4 shows a state when the slider 5 for lock-releasing is mounted on the one connector housing 4 having a flexible cantilever locking arm 3. The locking arm 3 includes on the same line: a pair of arm bodies 3a situated left and right extending in parallel to the connector-coupling direction; a locking part (connection part) 22 located between the pair of the arm bodies 3a at a front end (at an end) of the arm body 3a; and a pair of inclined guide projections 42 projecting from an outer surface of each arm body 3a. The locking part 22 has a perpendicular provisional locking surface 21 at a rear end thereof, and each guide projection 42 has an upward inclined surface 46 on the rear side thereof and a downward inclined surface 18 at the front side thereof. A locking projection 11 of the opposite connector housing 10 shown in FIG. 5 engages with an inner space 17 of the locking part 22.

The slider 5 has a flexible cantilever provisional locking arm 43 in the middle in the width direction thereof and a pair of lock-releasing projections 19 (situated at both sides left and right) at a little rear side from the front end of the provisional locking arm 43. Only one lock-releasing projection 19 is shown in the figure. The provisional locking arm 43 has a provisional locking projection 44 at the lower side of the front end, the provisional locking projection 44 has an inclined surface 44a at the rear end thereof, and the provisional locking arm 43 has a pair of following projections 45 at left and right of the front end thereof.

The lock-releasing projection 19 has an upward inclined surface 20a at least at the rear side thereof. The lock-releasing projection 19 is integrally formed on an inner surface at the front end of a flexible cantilever lock-releasing arm 37 in the connector-coupling direction. A protection bridge 47 at a front end of the slider 5 is located on a front end of the provisional locking arm 43 and the protection bridge 47 integrally continues to protection ribs 48 situated left and right sides.

FIG. 5 shows a state when the slider is provisionally locked to the one connector housing 4 and the one connector housing 4 is coupled with the opposite connector housing 10 having a locking projection (locking part) 11. The provisional locking projection 44 of the provisional locking arm 43 abuts against a locking surface 21 (FIG. 4) of the locking arm 3, so that the slider 5 is provisionally locked, then on this condition, as shown in FIG. 6, both connector housings 4 and 10 are coupled with each other. The locking projection 11 engages into the locking arm 3, so that the provisional locking projection 44 of the provisional locking arm 43 is lifted, thereby allowing the slider 5 to be slidable forward.

As shown in FIG. 6, when the slider 5 moves forward, simultaneously the provisional locking arm 43 climbs over the locking arm 3, and the lock-releasing projections situated left and right bend upward integrally with the lock-releasing arm 37 and climb over the guide projection 42 of the locking arm 3 so as to be located in front of the guide projection 42. Thereby, the slider 5 is completely locked.

When the slider 5 is moved backward on this condition, the lock-releasing projection 19 abuts against a front surface of the guide projection 42 and lifts the locking arm 3 in the lock-releasing direction. Thereby, the lock between both connector housing 4 and 10 is released. The slider 5 is moved backward to the provisional locking position. Of course, the male and female terminals are received in both connector housings 4 and 10.

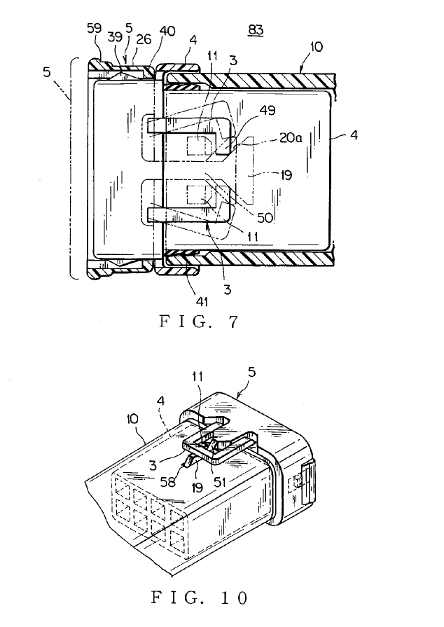

FIG. 7 shows the third preferred embodiment of a lock connector according to the present invention.

A lock connector 83 is characterized in that the locking arm 3 of the one connector housing 4 is made so as to bend not in the up-and-down direction but in the left-and-right direction. The lock-releasing projection (lock-releasing part) 19 of the slider 5 is located on the side of the locking arm 3 so as to bend the locking arm 3 in the lateral direction (or horizontal direction).

The locking arm 3 is formed as a pair of locking arms 3 located left and right. Each locking arm 3 can bend outwardly (i.e. in the left-and-right direction) around a supporting point, which is the rear end cantilever-supported. An end of each locking arm 3 is bent inwardly in a L-shape. The bent end thereof acts as a locking projection 49 and each locking projection (locking part) 11 of the connector housing 4 engages with the inside of each locking projection 49 so as to obtain the coupling between both connector housings 4 and 10. A lock-releasing arm 50 of the slider 5 for lock-releasing is located between the pair of the locking arms 3, a lock-releasing projection 19 at an end of the lock-releasing arm 50 has a rear inclined surface 20a at both sides left and right, and the inclined surface 20a comes in contact with an end of the locking projection 49 at an end position of the forward movement of the slider 5.

When the slider 5 is moved backward up to a position shown by an alternate long and two short dashes line in FIG. 7, the inclined surface 20a of the lock-releasing projection 19 slidably comes in contact with an end of the locking arm 3 while the inclined surface 20a bends the locking arm 3 outwardly on a horizontal plane (i.e. in the lock-releasing direction), thereby releasing the engagement of the locking arm 3 with the locking projection 11.

The other construction besides the above description is the same as that of the first or second preferred embodiment. The slider 5 having a rectangular tube shape covers the outer periphery of the connector housing 4. In FIG. 7, walls situated left and right of the one connector housing 4 are provided with respective triangle-shaped projections 39, each of which slidably comes in contact with corresponding projection 40 at a front end of the arm 26 situated left or right of the slider 5. Its structure will be explained in detail later on with reference to FIG. 12. In FIG. 7, the reference numeral 41 denotes a waterproof packing.

In the preferred embodiment shown in FIG. 7, the lock-releasing projection 19 of the slider 5 may be provided at a front end of the flexible lock-releasing arm 50, so that the lock-releasing projection 19 climbs over the front end of the locking arm 3 so as to be situated in front of the front end of the locking arm 3 like the lock-releasing arm 37 described in the second preferred embodiment (FIG. 4). Further, the number of the locking arm 3, the locking projection 11 or the inclined surface 20a of the lock-releasing projection 19 may be one instead of two (i.e. a pair).

FIGS. 8-11 show the fourth preferred embodiment of a lock connector according to the present invention.

A lock connector 84 is characterized in that a part of the slider 5 is allowed to enter into the lower side (i.e. inside) of the locking arm 3 of the one connector housing 4 so that the locking arm 3 is prevented from bending downward (i.e. inward).

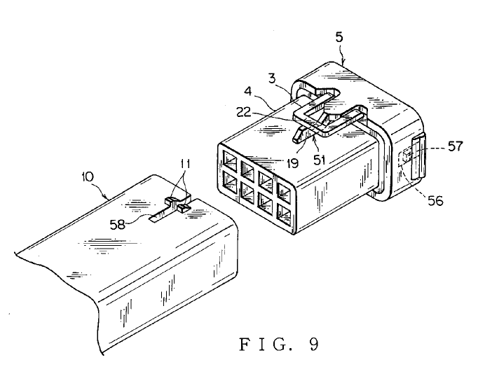

FIG. 8 shows a state when the slider 5 is separated from the one connector housing 4. FIG. 9 shows a state when the slider 5 is mounted (i.e. provisionally locked) to the one connector housing 4. As shown in FIG. 8, the connector housing 4 has the wide receiving part 23 at the rear half thereof and the narrow receiving part 14 at the front half thereof, wherein the rectangular tube-shaped slider 5 is slidably mounted into the receiving part 23 at the rear half. The flexible locking arm 3 having a C-shape is projectingly formed forward from a front end side of the receiving part 23 at the rear half.

The slider 5 is provided with a flexible lock-releasing arm 51 projectingly formed forward from the front end side of the upper wall 25. The lock-releasing arm 51 has the lock-releasing projection 19 at a front end thereof. The lock-releasing projection 19 has upward inclined surfaces 20a and 20c at both ends in the front and rear thereof. A recess part 52 is formed at the rear of the lock-releasing projection 19 of the lock-releasing arm 51. A rear end (i.e. base end) of the lock-releasing arm 51 continues integrally to a projecting wall 54 situated at the center of the upper wall 25 at an upward inclined side 53. As shown in FIG. 9, the rear end (i.e. base end) of the locking arm 3 enters into a notched part 55 situated at both sides of the projecting wall 54. An inverse trapezoid-shaped recess part 52 is formed between the lock-releasing projection 19 and the inclined side 53.

In FIG. 9, the lock-releasing arm 51 enters into the bottom side of the locking arm 3. A locking side 22 situated at a front end of the locking arm 3 engages with the recess part 52 (FIG. 8) of the lock-releasing arm 51. A locking projection 56 of the connector housing 4 engages with a middle part in the longitudinal direction of a groove part 57 of the slider 5.

The opposite connector housing 10 has a slit 58 for entering the lock-releasing arm 51 therein and a pair of locking projections (i.e. locking parts) 11 at both sides left and right of the slit 58 for corresponding to the locking arm 3. The one connector housing 4 receives female terminals with electric wire (not shown in the figure) therein and the opposite connector housing 10 receives male terminals (not shown in the figure) therein, thereby constructing the respective connectors.

A waterproof mat seal and a seal holder (not shown in the figure) are mounted on the rear of the one connector housing 4 and a projection 29 (see FIG. 3) as a stopper abutting against the rear end of the one connector housing 4 is formed at the rear end of the slider 5.

FIG. 10 shows a state when the one connector housing 4 is coupled with the opposite connector housing 10, wherein the one connector housing 4 enters inside the opposite connector housing 10. The locking projection 11 engages with the inside of the locking arm 3 and the lock-releasing arm 51 enters in and engages with the slit 58. The front side 22 of the locking arm 3 engages with between the locking projection 11 and the lock-releasing projection 19 on an outer surface of the upper wall of the opposite connector housing 10.

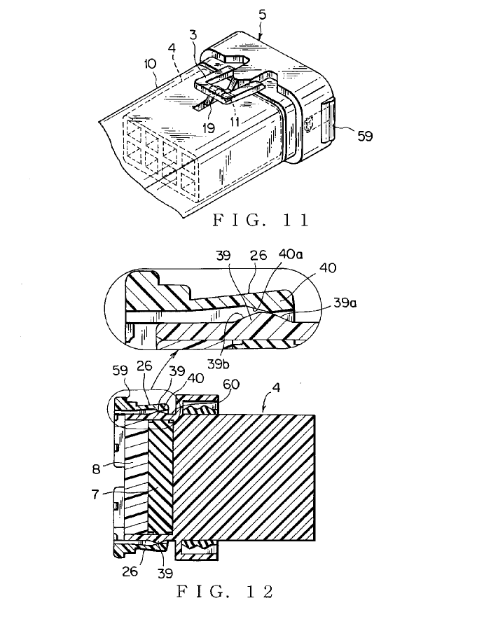

FIG. 11 shows a state when the slider 5 is moved backward so as to release the lock between both connector housings 4 and 10. The backward movement of the slider 5 is carried out by nipping an operation projection 59 situated at both sides with fingers. When the slider 5 is operated to be moving backward, the lock-releasing projection 19 lifts the locking arm 3 in the lock-releasing direction so as to release the engagement of the locking arm 3 with the locking projection 11. When both connector housings 4 and 10 are pulled backward on that condition, both connectors 4 and 10 are separated from each other.

According to the fourth preferred embodiment, since the lock-releasing arm 51 enters into the bottom side of the locking arm 3 so as to prevent the locking arm 3 from being deformed downward (i.e. in the lock-releasing direction), therefore the locking arm 3 is securely prevented from being resilience-fatigued or damaged. Further, since the slider 5 is operated to be moved backward on a condition that the lock-releasing arm 51 resiliently adheres to the lower surface of the locking arm 3, therefore the lock-releasing arm 19 securely lifts the locking arm 3 and the lock-releasing is precisely securely carried out.

FIGS. 12-15 show a structure, in which the slider 5 is automatically returns to the end position of its forward movement after the slider 5 is operated to be moved backward, of the lock connector shown in FIG. 3 (i.e. the first preferred embodiment). Such a structure can be applied to the second to fourth preferred embodiments besides the first preferred embodiment.

FIG. 12 shows a lateral cross sectional view of the lock connector, wherein projections 39 for returning are formed on side walls situated left and right of the connector housing 4 and flexible resilient arms (resilient members) 26 for returning are formed on side walls 72 (FIG. 14) situated left and right of the slider 5, the resilient arm 26 slidably coming in contact with the projection 39. The projection 39 has inclined surfaces 39a and 39b at front and rear thereof. As also shown in FIG. 3, the resilient arm 26 is projectingly formed at the front of an operation projection 59 situated at the rear end side of the slider 5 and has a projection 40 for returning at the front end side thereof. The projection 40 has an inclined surface 40a at the rear side thereof.

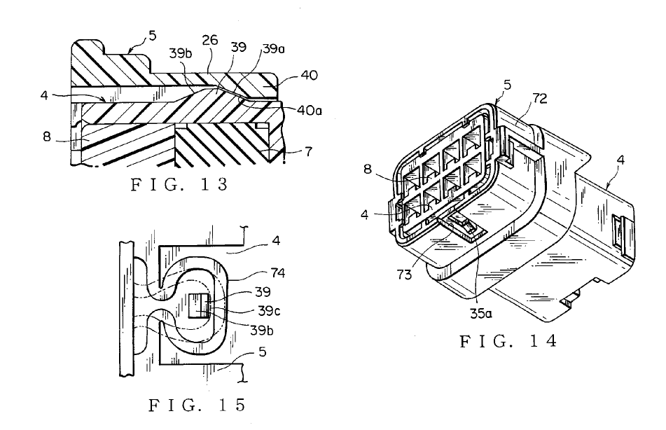

FIG. 12 shows a state when the slider 5 is moved backward like FIG. 3, and FIG. 13 shows a state of an initial position (forward advanced position) of the slider 5. As shown in FIG. 13, at the forward advanced position of the slider 5, the inclined surface 39a at the front side of the projection 39 of the connector housing 4 comes in contact with the inclined surface 40a at the rear side of the projection 40 of the resilient arm 26.

When the slider 5 is moved backward from the state described above as shown in FIG. 12, the inclined surface 40a of the projection 40 of the resilient arm 26 climbs on the inclined surface 39a at the front side of the projection 39 of the connector housing 4, the release of the lock between both connector housings 4 and 10 is carried out by the lock-releasing means 19 (FIG. 3). For example, after the separation of both connector housings 4 and 10 is carried out, when an operator keeps his hand away from the slider 5, the projection 39 of the connector housing 4 is relatively pushed backward by inward resilient force of the resilient arm 26, so that the slider 5 returns forward by the resilient force as shown in FIG. 13.

Even if the slider 5 is pulled strongly, a coming-off preventing means shown in FIG. 14 prevents the slider 5 from coming off backward. The coming-off preventing means includes: a flexible arm 35 (see FIG. 1) having a projection 35a formed on an outer surface of a lower wall of the connector housing 4; and a slit 73 formed on a lower wall of the slider 5, wherein the projection 35a abuts against a front end surface of the slit 73, thereby preventing the slider 5 from moving backward further.

The projection 35a has a perpendicular locking surface at the front side thereof and an inclined surface at the rear side thereof. In FIG. 14, the slider 5 is situated at its end position of forward movement (i.e. initial position) and the projection 35a is situated at the middle in the longitudinal direction of the slit 73. The coming-off preventing means for the slider 5 can be applied to the second to fourth preferred embodiments besides the first preferred embodiment.

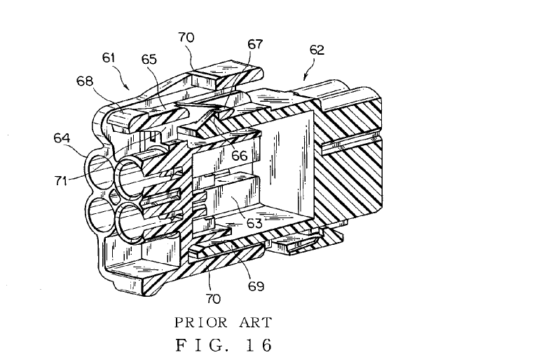

FIG. 15 shows an example, in which instead of the resilient arm 26 shown in FIG. 12, a resilient belt (resilient member) 74 having a ring-shape or half ring-shape is provided on a lower wall of the slider 5. The resilient belt 74 has resilient force for returning to a shape (i.e. ellipse-shape longer than is wide) shown with a solid line in FIG. 15. The resilient belt 74 surrounds the projection 39 of the lower wall of the connector housing 4 and comes in contact with the perpendicular locking surface 39c situated at the front side of the projection 39.

When the slider 5 is moved backward, the resilient belt 74 extends laterally with opposing its restoring force. When an operator keeps his hand away from the slider 5, the slider 5 moves forward by the restoring force of the resilient belt 74 so as to return to its initial position and the resilient belt 74 returns to the shape (i.e. shape longer than is wide) shown with a solid line in FIG. 15.

The initial shape of the resilient belt 74 may not necessarily be limited to the shape longer than is wide. It may be a round shape instead, for example. Further, the position of the resilient arm 26 shown in FIG. 12 or the position of the resilient belt 74 shown in FIG. 15 may not necessarily be limited to the position of the lower wall. It may be a position of a side wall instead, for example. Furthermore, the number of the resilient arm 26 or the resilient belt 74 may not necessarily be one. It may be plural instead. The returning means for returning the slider 5 shown in FIG. 15 can be applied to the second to fourth preferred embodiments besides the first preferred embodiment.

The aforementioned preferred embodiments are described to aid in understanding the present invention and variations may be made by one skilled in the art without departing from the spirit and scope of the present invention.

What is claimed is:

1. A lock connector comprising:
one connector housing having a flexible locking arm; and
an opposite connector housing having a locking part that engages with the locking arm,
wherein a slider for releasing a lock between the one connector housing and the opposite connector housing is mounted to the one connector housing and the slider has a lock-releasing part that bends the locking arm in a lock-releasing direction when the slider is moved in a connector-separating direction.

2. The lock connector according to claim 1, wherein the lock-releasing part has an inclined surface that comes in contact with and pushes the locking arm so as to bend the locking arm.

3. The lock connector according to claim 1, wherein the lock-releasing part is provided on a flexible lock-releasing arm and the lock-releasing part climbs over the locking arm so as to located in front of the locking arm.

4. The lock connector according to claim 1, wherein the lock-releasing part is located on a side of the locking arm so that the lock-releasing part is capable of bending the locking arm laterally.

5. The lock connector according to claim 1, wherein the lock-releasing part is provided on a flexible lock-releasing arm and the lock-releasing arm enters a side opposite to a lock-releasing bending of the locking arm so that the lock-releasing part is located in front of the locking arm.

6. The lock connector according to claim 1, wherein the slider has a resilient member for returning and the resilient member comes in contact with and pushes a projection of the one connector housing when the slider is moved backward.

7. The lock connector according to claim 6, wherein the resilient member is a resilient arm and the resilient arm comes in contact with and pushes an inclined surface situated in front of the projection when the slider is moved backward.

8. The lock connector according to claim 1, wherein the slider is a member that covers an outer periphery of the one connector housing.
